(19) United States
(12) Patent Application Publication
(10) Pub. No.: US 2012/0079713 A1
(43) Pub. Date: Apr. 5, 2012

(54) MANUFACTURING METHOD OF PRISMATIC SEALED CELL

(75) Inventors: Hiroshi Hosokawa, Kasai-shi (JP); Haruhiko Yamamoto, Kasai-shi (JP)

(73) Assignee: SANYO ELECTRIC CO., LTD., Osaka (JP)

(21) Appl. No.: 13/241,658

(22) Filed: Sep. 23, 2011

(30) Foreign Application Priority Data
Sep. 30, 2010 (JP) 2010-221811

(51) Int. Cl. H01M 10/04

(52) U.S. Cl. 29/623.2

(57) ABSTRACT

The present invention aims to provide a method for manufacturing a prismatic sealed cell having a good reliability of sealing. This object is realized with the following configuration.

The method of manufacturing a sealed cell comprises the following steps: fitting a substantially planar rectangular sealing plate to the opening of a prismatic outer casing; and irradiating a high energy beam so that the spot center of the beam is shifted (offset) from the fitted portion to the sealing plate side in order to seal the sealing plate and the outer casing.

In this method, the maximum distance from the outer periphery the sealing plate to the spot center at the four corners of the sealing plate is longer than the distance from the outer periphery of the sealing plate to the spot center at a linear portion of the sealing plate.

### BACKGROUND OF THE INVENTION

1. Technical Field

The present invention relates to a method for manufacturing a prismatic sealed cell, and specifically to a method to weld an outer casing and a sealing plate using a high energy beam such as a laser.

### BACKGROUND ART

A non-aqueous electrolyte secondary cell, which provides a high energy density and high capacity, has been widely used as a driving power source for small mobile information terminals such as mobile phones and laptop computers. In addition, a non-aqueous electrolyte secondary cell has been also used in applications where high current is required, including driving power sources of electric vehicles (EV) and hybrid electric vehicles (HEV).

A kind of non-aqueous electrolyte secondary cell is fabricated by spirally winding positive and negative electrode plates via a separator, pressing into a flat shape, inserting the flat electrode body into an outer casing, fitting a sealing plate, and welding the sealing plate with a high energy beam such as a laser. This kind of non-aqueous electrolyte secondary cell has the following features: the cell has high sealing property; it is easy to take out large electric current from the cell; and it is easy to connect the cells in parallel and/or series. For these reasons, this non-aqueous electrolyte secondary cell is used in the above-stated applications.

Laser sealing techniques for sealing this type of cell are described in, for example, the following Patent Documents 1 to 8.
[Patent Document 1]
Japanese Patent Application Publication No. H08-315788
[Patent Document 2]
Japanese Patent Application Publication No. S60-56358
[Patent Document 3]
Japanese Patent Application Publication No. H11-104866
[Patent Document 4]
Japanese Patent Application Publication No. S60-65443
[Patent Document 5]
Japanese Patent Application Publication No. H08-315789
[Patent Document 6]
Japanese Patent Application Publication No. 2008-84803
[Patent Document 7]
Japanese Patent Application Publication No. 2003-282029

[Patent Document 8]
Japanese Patent Application Publication No. H08-250079

Patent Document 1 discloses a technique in which a lid plate made of a metal plate is fitted into a rectangular opening formed at one end of a metal casing, and then sequence laser welding is performed with the center of laser beam spot shifting (offsetting) toward the inside of the fitting portion. The document states that this technique can prevent a decrease in welding strength and shape defects such as melting and dripping of the outer periphery of the prismatic casing and occurrence of a depression in the welding area because the outer peripheral edge of the melting potion hardly reaches the outer peripheral edge of the prismatic casing depending on the offset.

Patent Document 2 relates to a sealing method using irradiation of a laser beam on a fitted portion between a cell lid and the opening edge of a cell casing. In this method, the document discloses a technique in which the irradiative position of the laser beam is shifted by 5 to 30% of the welding diameter from the junction between the cell lid and the opening edge of the cell casing. The document states that this technique can prevent occurrence of pinholes.

Patent Document 3 discloses a technique in which a container body and a lid, both of which are made from aluminum or aluminum alloy are joined together so that the ratio of the depth (D) of the melted joined portion to the width (ω) of the melted joined portion is from 1 to 5. The document states that according to this technique, there can be produced in high yield a sealed container having a joint with high sealing property and no root cracking without raised temperature in the container.

Patent Document 4 relates to a method for laser-welding a protruding periphery of a cell lid and an edge of the opening of a cell container. In this method, the document discloses a technique in which a laser beam is irradiated to a position shifted away from the fitting portion between the protruding periphery and the edge of the opening. The document states that this technique can prevents elements accommodated in the cell container from being adversely affected by the heat.

Patent Document 5 relates to a method of forming a sealed container of a prismatic cell by fitting a lid plate made of a metal plate to the opening of a prismatic casing having linear sides and corners with a predetermined radius of curvature, and then by laser-welding the fitted portion. In this method, the document discloses a technique in which the radius of curvature of the trace of the laser spot center is smaller than the radius of curvature of the corner of the fitted portion. The document states that according to this technique, the fitted portion between the linear sides and the corners with a predetermined radius of curvature is successfully laser welded over its entire circumference.

Patent Document 6 relates to a method for manufacturing a sealed cell that is sealed by irradiating laser beam and welding an aluminum-based metal outer casing and an aluminum-based metal lid plate placed on the opening of the outer casing. In this method, the document discloses a technique in which: the laser beam is a CW type; the theoretical spot diameter of the beam is 0.1 mm or more and 0.6 mm or less; the power density is 5 kW/mm² or more and 33 kW/mm² or less. The document states that this technique allows the lid plate and the outer casing made of an aluminum-based metal to be sealed using a continuous wave type laser welding equipment at a speed of 100 mm/s or more.

Patent Document 7 relates to a method for joining a fitted portion between the outer casing and the sealing plate by an energy irradiation process drawing a substantially rectangular pattern using an energy beam. In this method, the document discloses a technique in which a drawing starting point S of the energy irradiation process is positioned at the corner and arranged so as to be positioned outwardly or inwardly of the fitted portion to be bonded, or a drawing end point E is positioned at the corner and arranged so as to be positioned outwardly or inwardly of the fitted portion to be bonded. The document states that this technique stabilizes weld quality and improves a yield of prismatic cells.

Patent Document 8 relates to a method for forming a sealed container of a prismatic cell by fitting a lid plate made of a metal plate into a rectangular opening that is formed at one end of a metal case and consists of corners having a predetermined radius of curvature and linear peripheries and by laser-welding the fitted portion having a substantially rectangular shape with round corners. In this method, the document discloses a technique in which the welding starts at a linear periphery of the fitted portion, and then subsequently moves along portions to be welded, and ends at the linear periphery. The document states that this technique can reduce a variation in weld melting and thereby welding defects can be prevented.

However, since welding defects such as voids may occur even when using each of the above techniques, further improvements have been desired.

### BRIEF SUMMARY OF THE INVENTION

The present invention aims to provide a method for manufacturing a prismatic sealed cell suppressing occurrence of welding defects and having a good reliability of sealing.

The problem to be solved by the present invention is described below more specifically. FIG. 1 shows a sealed cell using a prismatic outer casing having a bottom. The prismatic sealed cell has the following structure: a sealing plate 2 having a substantially planar rectangular shape is fitted to the openings in an outer casing 1 in which an electrolyte solution and an electrode body having positive and negative electrodes are accommodated; and the fitted portion is sealed by welding using a high energy beam such as a laser. In addition, the cell also has a structure in which the positive and negative electrodes of the electrode body are respectively connected to positive and negative external terminals 3 and 4 projecting from the sealing plate 2, and thereby electrical energy generated inside is extracted to the outside.

When strength of the laser welding between the outer casing 1 and the sealing plate 2 is low, the welding may be destroyed due to shock, vibration or the like, which can cause leakage of the solution. Therefore, the strength of the laser welding must be sufficiently high.

However, since the wall thickness of the outer casing 1 perpendicular to the laser beam (lateral direction) is small, laser heat is difficult to escape laterally (the direction perpendicular to the cell height). Meanwhile, since the sealing plate 2 is flat, the heat is easy to escape laterally. Thus, when the laser is irradiated with the middle portion between the outer casing 1 and the sealing plate 2 as a laser spot center, an imbalance of heat distribution occurs, i.e. the material of the outer casing 1 melts more deeply than the melting position of the sealing plate 2. This leads to the following problems.
(1) As shown in FIG. 6(c), a melt-solidified portion 5 of the outer casing 1 is deeper than that of the sealing plate 2. This depth imbalance of the melt-solidified portion 5 inhibits to provide sufficient weld strength.
(2) Due to the unevenness of the melting state, the melted material on the side of the outer casing 1 mainly flows into the gap between the outer casing 1 and the sealing plate 2. This inflow of the material draws circumjacent materials of the outer casing 1 to the gap side, and thus a portion having a decreased thickness is generated in the outer casing 1 (cf. FIG. 7(a)). This portion having a decreased thickness leads to a reduction in weld strength.
(3) When the melted material of the outer casing 1 comes in contact with the sealing plate 2 at a deep position, the residual heat melts the sealing plate 2, and thus the above-described portion having a decreased thickness is surrounded with the melted material to form a void. Although this void moves upward (the upper surface side) because of buoyancy, since the melted material is solidified to form a melt-solidified portion 5 before the void gets out, the void remains in the melt-solidified portion 5 (cf. FIG. 7(b)). This void may lead to a decrease in weld strength.

On the other hand, increasing specific energy is also required for a sealed cell. For this purpose, as the material of the sealing plate and the outer casing, lightweight aluminum-based materials (pure aluminum and aluminum alloy) are used. However, since aluminum-based materials have a high thermal conductivity, heat is easy to escape, and thus welding defects tend to occur. Therefore, even when using lightweight aluminum-based materials, a highly reliable welding method capable of suppressing occurrence of welding defects is required.

The invention to solve the above problems is configured as follows. The invention relates to a method of manufacturing a sealed cell comprising the following steps: fitting a substantially planar rectangular sealing plate to the opening of a prismatic outer casing: and irradiating a high energy beam so that the spot center of the beam is shifted (offset) from the fitted portion to the sealing plate side in order to seal the sealing plate and the outer casing. In this method, the following formulas are satisfied: L3<L2 and L3<L1, wherein L1 is defined as the maximum distance from the outer periphery the sealing plate to the spot center at a corner to be welded first among the four corners of the sealing plate, L2 is defined as the maximum distance from the outer periphery the sealing plate to the spot center at the other corners than the corner to be welded first, and L3 is defined as a distance from the outer periphery of the sealing plate to the spot center at a linear portion of the sealing plate.

In a welding using a high energy beam such as a laser, when the laser spot center is shifted from the fitting portion to the sealing plate side, the area of the laser spot irradiating the outer casing is decreased, and thereby thermal energy directly added to the outer casing is decreased. On the other hand, the area of the laser spot irradiating the sealing plate is made larger, and thus thermal energy directly added to the sealing plate is increased. As a result, a heat balance between the outer casing and the sealing plate becomes good, and the depth balance of the melt solidification can be kept, and thereby occurrence of voids in the melt-solidified portion can be prevented.

Also, when performing the welding with the laser spot center shifting (offsetting) toward the sealing plate, the melted material of the sealing plate mainly flows into a gap between the outer casing and the sealing plate. However, since the sealing plate has a sufficient thickness compared to the outer casing, the effect of the decrease in thickness due to the inflow of material can be made extremely small.

In order to prevent such a problem that the corner is caught during fitting the outer casing and the sealing plate, it is ensured that the gap between the sealing plate and the outer casing at the corner is more than the gap at the linear portion (cf. FIGS. 3(b) and 3(c)). However, since thermal conductivity at the gap is lower than that at the outer casing or the sealing plate, an imbalance tends to occur in heat distribution at the corners between the sealing plate and the outer casing. In the above configuration, the maximum distances from the outer periphery of the sealing plate to the spot center at the corners (L1 and L2) are larger than the distance from the outer periphery of the sealing plate to the spot center at the linear portion (L3). For this reason, the imbalance of heat distribution between the outer casing and the sealing plate at the corners is eliminated. Therefore, it can be prevented that welding defects such as voids occur in the melt-solidified portion at the corners.

These effects act synergistically to provide a prismatic sealed cell having sealing reliability and suppressing occurrence of welding defects.

Herein, a substantially planar rectangular shape includes, of course, a planar square or rectangular shape, and further includes a planar square or rectangular shape with round or chamfered corners and the shape of an athletics track.

Also, the phrase “a laser spot center is shifted from the fitted portion toward the sealing plate” means that a laser spot center is shifted (offset) from the fitted portion (the center of the gap between the sealing plate and the outer casing) toward the sealing plate. Therefore, even if the spot center is focused on, for example, the outer periphery of the sealing plate, it is within the scope of the present invention.

The “distance from the outer periphery of the sealing plate to the spot center” is defined as a positive value when the laser spot center is positioned on the sealing plate, while it is defined as a negative value when the laser spot center is positioned on the outer casing or on the gap between the sealing plate and the outer casing.

In the above configuration, the following may be satisfied: L2<L1.

Because the materials of the sealing plate and the outer casing thermally expand due to heat of the high energy beam, dimensions of the sealing plate and the outer casing increase with time of the welding (heat accommodation). However, the effect of the heat at the corner to be welded first is much less than the effect at the other corner since the heat expansion has not yet progressed. Therefore, a substantial offset at the corner to be welded first is apt to be smaller than that at the other corners, and thus weld defects can easily occur due to the above-described imbalance of heat distribution.

In the above configuration, it is secured that the maximum distance L1 from the spot center to the outer periphery of the sealing plate at the corner to be welded first is longer than the maximum distance L2 from the spot center to the outer periphery of the sealing plate at the other corners. Thereby, since substantial offsets are almost similar at all corners, it can be prevented that welding defects such as voids occur in the melt-solidified portion at the corner to be welded first.

In the above structure, L1 may be from 50 to 380 μm, L2 may be from 20 to 350 μm, and L3 may be from 0 to 250 μm.

When the offset (the distance from the outer periphery to the laser spot center of the sealing plate) is too small, the heat on the outer casing easily becomes excessive in the heat balance between the outer casing and the sealing plate. In contrast, when the offset is too large, the sealing plate side tends to have excessive heat in thermal balance, and variation in the welding state is increased in the case that high energy beam irradiation is out of position. For this reason, the yield rate of the cell is deteriorated. In view of the above, it is preferable that the maximum offset L1 at the corner to be welded first is from 50 to 380 μm, the maximum offset L2 at the other corners is from 20 to 350 μm, and the offset L3 at the linear portion is from 0 to 250 μm. At the linear portion, the offset (L3) is more preferably from 10 to 250 μm. Furthermore, regarding the offset L3 at the linear portion, the maximum offset does not need to be considered, and it is preferable that the distance from any point at the linear portion of the outer periphery of the sealing plate to the laser spot center closest to the point falls in the above range throughout the linear portion.

In addition, as shown in FIGS. 3(b) and 3(c), it is preferable to gradually vary the offset at the corner. Preferably, the offset at the corner to be welded first is gradually varied between L3 and L1, and the offset at the other corners is gradually varied between L3 and L2.

In the above structure, the sealing plate may be made of pure aluminum or aluminum alloy, and the prismatic outer casing may be also made of pure aluminum or aluminum alloy.

Pure aluminum and aluminum alloy can increase specific energy because of their light weight, but have a problem that heat escapes easily because of their high thermal conductivity However, by adopting the method of the present invention, there can be obtained a lightweight prismatic sealed cell having excellent sealing reliability. The materials of the outer casing and the sealing plate may be identical or different.

As the high energy beam, a laser, an electron beam and the like can be used. Among them, a laser beam is preferably used.

In addition, when a continuous wave type laser (CW laser) is used as a laser, the time required for the laser welding process can be shortened compared with a pulsed laser.

### BRIEF DESCRIPTION OF THE DRAWINGS

FIG. 1 is a perspective view of a prismatic sealed cell.

FIG. 2 is a drawing illustrating a method of laser scanning of a prismatic sealed cell according to the present invention. FIG. 2(a) is a perspective view, FIG. 2(b) is a planar view, and FIG. 2(c) is a sectional view after laser welding.

FIG. 3 is a drawing showing the position through which the laser spot center passes during welding the sealing plate. FIG. 3(a) is a planar view of the sealed cell, FIG. 3(b) is an enlarged view of the vicinity of a corner to be welded first, and FIG. 3(c) is an enlarged view of the vicinity of the other corners.

FIG. 4 is a graph showing the relationship between “the distance between the laser focus and the fitting portion of the sealing plate and the outer casing” and “the temperature difference between the sealing plate and the outer casing during laser welding”.

FIG. 5 is a diagram showing simulation results of temperature distribution in the sealing plate and the outer casing when the offset is 85 μm.

FIG. 6 is a diagram for explaining a method of laser scanning of a conventional prismatic sealed cell. FIG. 6(a) is a perspective view, FIG. 6(b) is a planar view, and FIG. 6(c) is a sectional view after laser welding.

FIG. 7 is a sectional view explaining a defect point generated by laser scanning of the conventional prismatic sealed cell. FIG. 7(a) shows a decrease in thickness, and FIG. 7(b) shows occurrence of a void.

FIG. 8 is a diagram showing simulation results of temperature distribution in the sealing plate and the outer casing when the offset is −15 μm.

### DETAILED DESCRIPTION OF THE INVENTION

### Embodiments

The embodiment for carrying out the invention will be described below with reference to drawings.

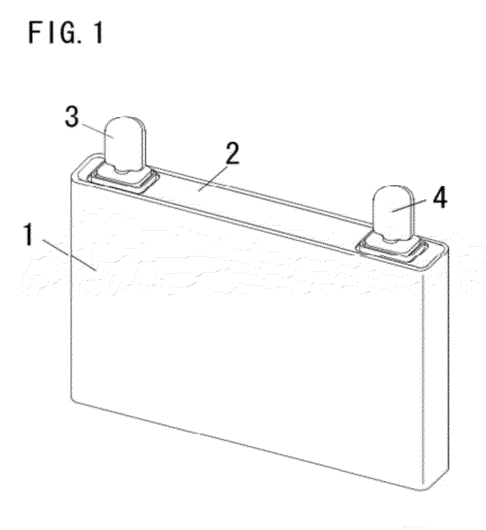

FIG. 1 is a perspective view of a prismatic sealed cell according to this Embodiment. The prismatic sealed cell has a structure as follows: a sealing plate 2 is fitted into the opening of an outer casing 1 in which an electrolyte and an electrode body having positive and negative electrodes are accommodated, and the fitted portion is sealed with laser welding. In addition, the positive and negative electrodes of the electrode body are connected to positive and negative external terminals 3 and 4 projecting from the sealing plate 2, respectively. Thereby, electrical energy generated inside is extracted to the outside.

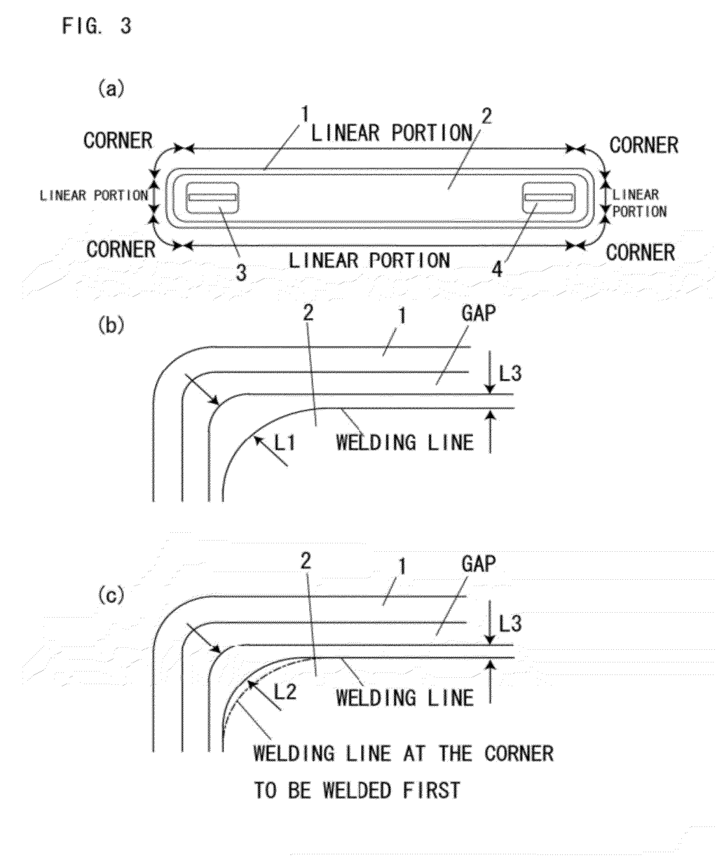

In addition, as shown in FIG. 3(a), the sealing plate 2 is a planar rectangle with rounded corners, and has four corners and four linear portions between the corners.

Herein, as a material of the sealing plate 2 and the outer casing 1, an aluminum-based material (pure aluminum, aluminum alloy) with lightweight and excellent workability is preferably used. The materials of the outer casing 1 and the sealing plate 2 may be identical or different.

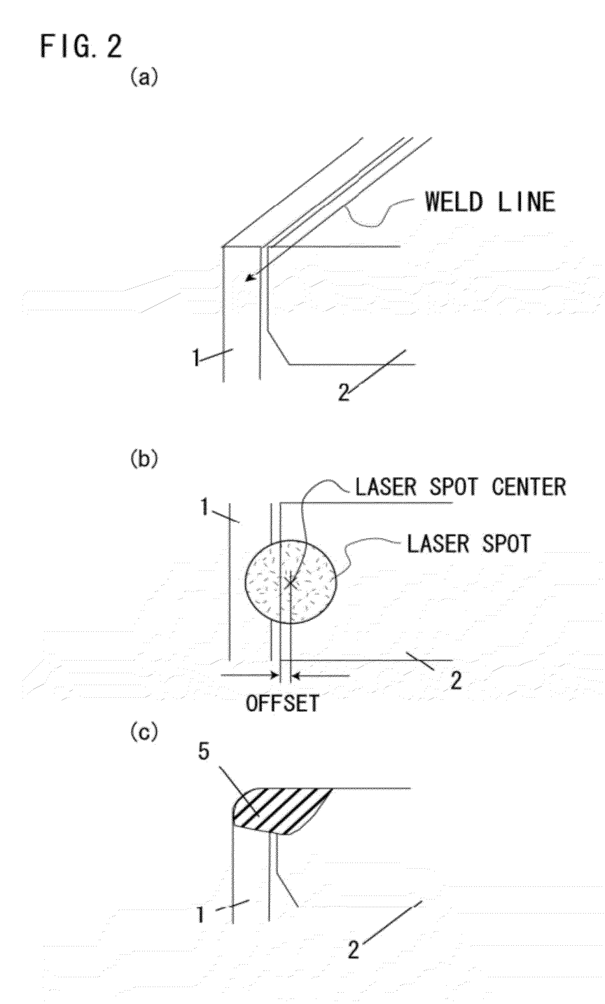

In addition, chamfered portions are formed at the underside edges of the sealing plate 2 (cf. FIGS. 2(a) and 2(c)). This is intended to be easy to insert the sealing plate 2 into the opening of the outer casing 1, but the chamfered portion is not an essential component of the present invention.

### (Fabrication of Cell)

The following describes a method for fabricating a cell according to an embodiment of the invention.

### <Preparation of Positive Electrode>

A positive electrode active material containing lithium cobalt composite oxide (LiCoO₂), a carbon-based conductive agent such as acetylene black or graphite, and a binder containing polyvinylidene fluoride (PVDF) are weighed in the mass ratio of 90:5:5, and then these are mixed with N-methyl-2-pyrrolidone to prepare a positive electrode active material slurry.

Next, using a die coater, a doctor blade or the like, the positive electrode active material slurry is applied in a uniform thickness on both sides of a positive electrode core made of aluminum foil. However, the slurry is not applied at an edge of the positive electrode core to partially expose the core.

Then, this plate is passed through a dryer for volatizing and removing N-methyl-2-pyrrolidone to prepare a dried plate. Thereafter, this dried plate is rolled using a roll press to fabricate a positive electrode.

As a positive electrode active material used in the lithium ion secondary cell according to this Embodiment, in addition to lithium cobalt composite oxide as shown above, the following lithium-containing transition metal composite oxide can be used alone or as a mixture of two or more: for example, lithium nickel composite oxide (LiNiO₂); lithium manganese composite oxide (LiMn₂O₄); lithium iron composite oxide (LiFeO₂); olivine type lithium iron phosphate (LiFePO₄); and oxides in which a part of the transition metals contained in the above oxides is substituted with other elements.

### <Preparation of Negative Electrode>

A negative electrode active material containing artificial graphite, a binder containing styrene butadiene rubber and a thickening agent containing carboxymethylcellulose are weighed in a mass ratio of 98:1:1, and mixed with an appropriate amount of water to prepare a negative electrode active material slurry.

Next, using a die coater, a doctor blade or the like, the negative electrode active material slurry is applied in a uniform thickness on both sides of a negative electrode core made of copper foil. However, the slurry is not applied at an edge of the negative electrode core to partially expose the core.

Then, this plate is passed through a dryer for volatizing and removing water to prepare a dried plate. Thereafter, this dried plate is rolled using a roll press to fabricate a negative electrode.

As the negative electrode material used in the lithium ion secondary cell according to this embodiment, the following can be used: for example, carbonaceous materials such as natural graphite, carbon black, coke, glassy carbon, carbon fibers and sintered materials thereof; and mixtures of the above-listed carbonaceous materials with at least one selected from the group consisting of lithium metal, lithium alloy, and metal oxides that can intercalate and deintercalate lithium.

### <Fabrication of Electrode Assembly>

The negative and positive electrodes and a separator made of microporous film of polyethylene are disposed so that the positive electrode core exposed portion protrudes at one end, and the negative body core exposed portion protrudes at the other end. Thereafter, they are wound with a winder, an insulative winding stop tape is sticked, and then the wound member is pressed to complete a flat electrode assembly. The resulting electrode body has a structure in which overlapping positive electrode core exposed portions protrude from one end of the flat electrode assembly while overlapping negative electrode core exposed portions protrude from the other end of the flat electrode assembly.

### <Attachment of Current Collectors>

Thereafter, a positive electrode current collector is attached to the positive electrode core exposed portion, and a negative electrode current collector to the negative electrode core exposed portion. In both of the electrodes, resistance welding is used.

### <Preparation of Electrolyte Solution>

Ethylene carbonate (EC), propylene carbonate (PC) and diethyl carbonate (DEC) are mixed in the volume ratio of 1:1:8 (when converted at 1 atm and 25° C.) to prepare a non-aqueous solvent. Then, LiPF₆ as an electrolyte salt is dissolved at 1.0 M (mol/l) into the non-aqueous solvent to prepare an electrolyte solution.

Besides the aforementioned combination of EC, PC, and DEC, the non-aqueous solvent may be a mixture of a high dielectric solvent having a high solubility of lithium salt and a low-viscosity solvent. Examples of the high dielectric solvent include ethylene carbonate, propylene carbonate, butylene carbonate, and γ-butyrolactone. Examples of the low-viscosity solvent include diethyl carbonate, dimethyl carbonate, ethyl methyl carbonate, 1,2-dimethoxyethane, tetrahydrofuran, anisole, 1,4-dioxane, 4-methyl-2-pentanone, cyclohexanone, acetonitrile, propionitrile, dimethylformamide, sulfolane, methyl formate, ethyl formate, methyl acetate, ethyl acetate, propyl acetate, and ethyl propionate. In addition, the non-aqueous solvent may be a mixture of one or more high dielectric solvents and one or more low-viscosity solvents as listed above.

In addition, besides LiPF₆ used in the embodiment, examples of electrolyte salts include LiN(C₂F₅SO₂)₂. LiN(CF₃SO₂)₂, LiClO₄ and LiBF₄, all of which can be used alone or in combination of two or more.

Furthermore, known additives such as vinylene carbonate, vinyl ethylene carbonate, cyclohexyl benzene and tert-amyl benzene may be added to the non-aqueous electrolyte.

### <Assembly of Cells>

The positive and negative electrode current collectors of the flat electrode assembly are connected to positive and negative external terminals formed in a sealing plate, respectively. Then, the sealing plate made of aluminum is fitted to the opening of a prismatic outer casing. Thereafter, the fitted portion is sealed with a laser irradiation so that its laser spot center is shifted from the fitted portion (the center of the gap between the sealing plate and the outer casing) to the sealing plate side. Then, the above electrolyte solution is poured through a hole (not shown) formed in the sealing plate into the outer casing made of aluminum, and then the hole is sealed to complete a prismatic sealed cell.

The laser welding method is described in more detail with reference to FIGS. 2 and 3. FIG. 2 is a drawing to explain a laser scanning method for sealing the prismatic cell according to the present invention. FIG. 2(a) is a perspective view, FIG. 2(b) is a plan view, and FIG. 2(c) is a cross-sectional view after laser welding. FIG. 3 is a diagram illustrating the laser welding. FIG. 3(a) is a plan view of a sealed cell according to this Embodiment, FIG. 3(b) is an enlarged plan view near the corner to be welded first, and FIG. 3(c) is an enlarged plan view near one of the other corners.

In this Embodiment, in order to prevent such a problem that the corner is caught during fitting to lead to bending, the gap between the sealing plate and the outer casing at the corner is more than the gap at the linear portion (cf. FIGS. 3(b) and 3(c)).

In welding the fitted portion between the outer casing 1 and the sealing plate 2, as shown in FIG. 2(b), the welding is performed with laser irradiation so that the laser spot center is shifted to the sealing plate 2 side from the fitted portion (i.e. the center of the gap between the outer casing 1 and the sealing plate 2). The line through which the laser spot center passes is a weld line shown in FIGS. 2(a), 3(b) and 3(c).

As shown in FIGS. 3(b) and 3(c), the offset (the distance from the outer periphery of the sealing plate 2 to the laser spot center) is gradually changed at the corner.

When L1 is defined as the maximum offset at the corner to be welded first among the four corners of the sealing plate, L2 is defined as the maximum offset at the other corners, and L3 is defined as the offset at the linear portion, then each value is set as follows: L3<L2 and L3<L1. In a word, the offset at the corners is more shifted to the sealing plate side than that at the linear portion (cf. FIGS. 3(b) and 3(c)). Preferably, L1 and L2 are 20 to 150 μm longer than L3.

In addition, L2<L1 is preferable. That is, it is preferable that the welding line at the corner to be welded first is more shifted to the sealing plate side than that at the other corners (cf. FIG. 3(c)).

Preferably, the diameter of the laser spot in the laser welding is 0.4 to 0.6 mm. And a laser welding apparatus using continuous wave type laser (CW laser) is preferably used. In addition, laser-scanning speed is preferably 40 to 200 mm/sec, and laser power density is preferably 0.5 to 1.7×10¹⁰ W/m². In addition, preferably, the offsets (the distance from the outer periphery of the sealing plate to the spot center; cf. FIG. 2(b)) are from 0 to 250 μm at the linear portion, at most from 50 to 380 μm at the corner to be welded first, and at most from 20 to 350 μm at the other corners. Also, the offset of the laser beam is preferably smaller than “[half of the diameter of the laser spot] minus [the gap of the fitted portion]” (so that laser beam is irradiated directly to the outer casing side).

### EXPERIMENTAL EXAMPLE

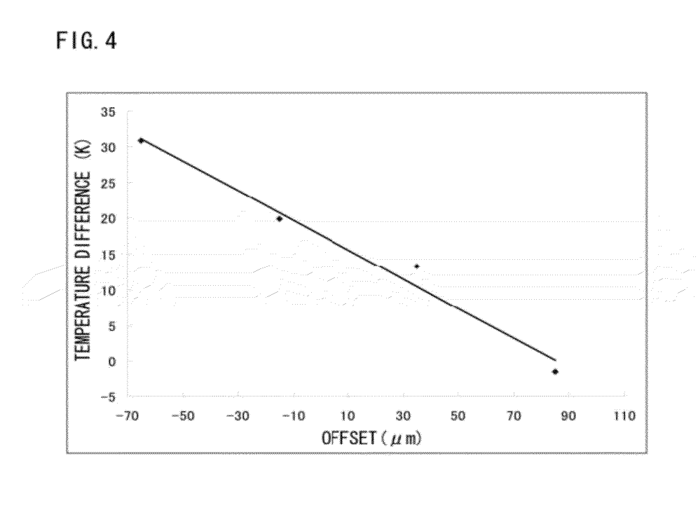

As shown in the following Welding conditions 1 to 4, while varying the offset, the inventors have simulated (cf. FIG. 2(b)), using finite element analysis, the relationship of the offset with the maximum temperatures of the sealing plate and the outer casing raised by laser welding at the position of 0.4 mm from the upper surface (laser beam irradiation surface). The results are shown in Table 1 and FIG. 4. The following condition is used in the simulation.

The laser spot center is shifted (offset) from the outer periphery of the sealing plate as follows.
Welding condition 1: 65 μm offset to the outer casing side.
Welding condition 2: 15 μm offset to the outer casing side.
(corresponding to the center of the gap between the sealing plate and the outer casing)
Welding condition 3: 35 μm offset to the sealing plate side.
Welding condition 4: 85 μm offset to the sealing plate side.
Wall thickness of the outer casing: long side 0.4 mm, short side 0.5 mm
Thickness of the sealing plate: 1.4 mm
Height of the chamfered portion on the underside of the sealing plate: 0.3 mm
Gap between the sealing plate and the outer casing: 0.03 mm
Materials of the sealing plate and the outer casing: aluminum (JIS A1050)
Laser spot diameter: 600 μm
Power density: 0.7×10¹⁰ W/m²
Scanning Speed: 60 mm/sec

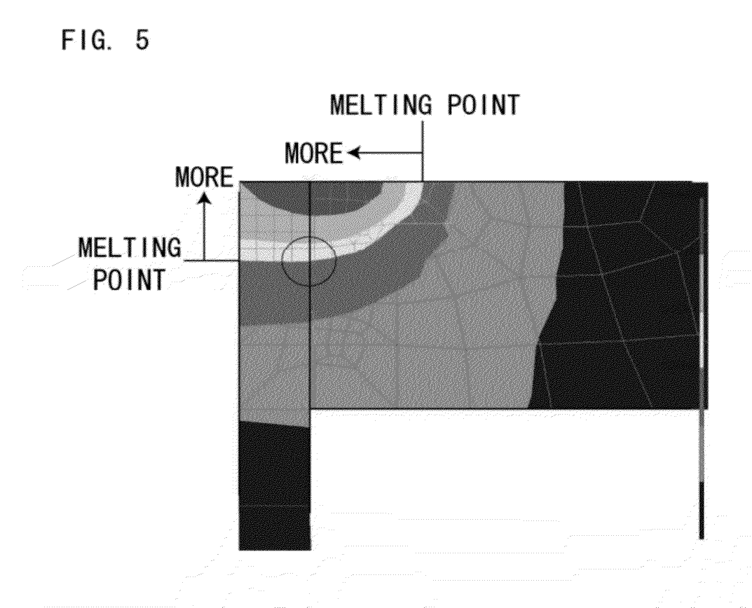

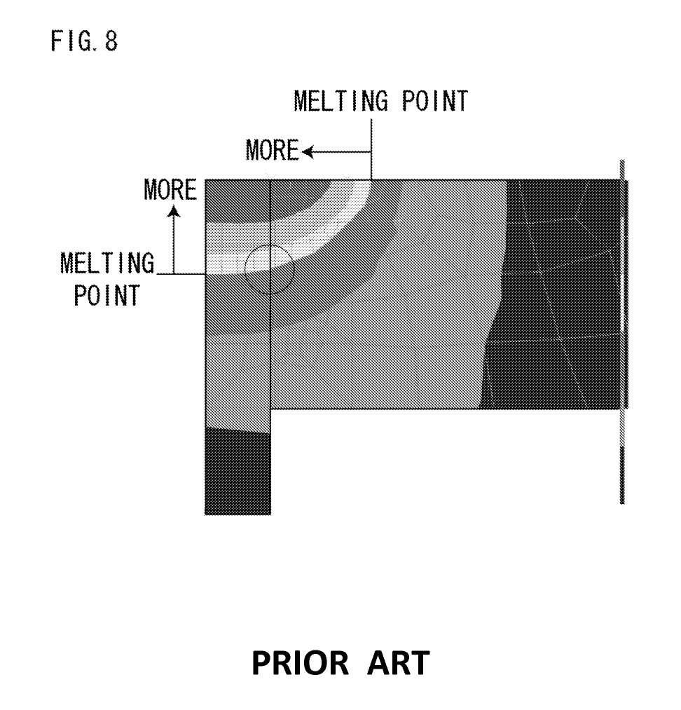

In addition, the inventors have simulated the maximum temperature distribution of the outer casing and the sealing plate in the cases of welding under the above Welding conditions 2 and 4 by means of finite element analysis. The results are shown in FIG. 5 (Welding conditions 4) and FIG. 8 (Welding conditions 2).

TABLE 1

| | | Outer casing | Sealing plate | Temperature |
|---|---|---|---|---|
| Welding | Offset | temperature | temperature | difference |
| Condition | (μm) | (K) | (K) | (K) |
| 1 | −65 | 1193.7 | 1162.9 | 30.8 |
| 2 | −15 | 1124.9 | 1105.0 | 19.9 |
| 3 | 35 | 1141.0 | 1127.7 | 13.3 |
| 4 | 85 | 1039.1 | 1040.5 | −1.4 |

Above Table 1 and FIG. 4 reveal that with the increase of the distance (offset) between the laser spot center and the inner edge of the outer casing, the temperature difference between the sealing plate and the outer casing (the value obtained by subtracting the temperature of the sealing plate from that of the outer casing) tends to decrease.

This can be considered as follows. The thickness (wall thickness) of the outer casing in the direction perpendicular to the laser beam is small, and therefore the laser heat hardly escapes. Meanwhile, since the sealing plate is flat, the laser heat easily escapes in the direction perpendicular to the laser beam. For this reason, when the laser spot center is located at the middle of the outer casing and the sealing plate (Welding condition 2) or on the outer casing side (Welding condition 1), the maximum temperature of the outer casing at the point of 0.4 mm from the upper surface is significantly larger than that of the sealing plate.

In contrast, when the laser spot center is shifted to the sealing plate side (Weld conditions 3 and 4), since the area of the laser spot irradiating the outer casing is decreased, the heat energy directly applied to the outer casing is also decreased. Meanwhile, since the area of the laser spot irradiating the sealing plate is increased, the heat energy directly applied to the sealing plate is also increased. Consequently, as the offset increases, the difference is decreased between the outer casing and the sealing plate in the maximum temperature at the point of 0.4 mm from the upper surface (cf. FIG. 4).

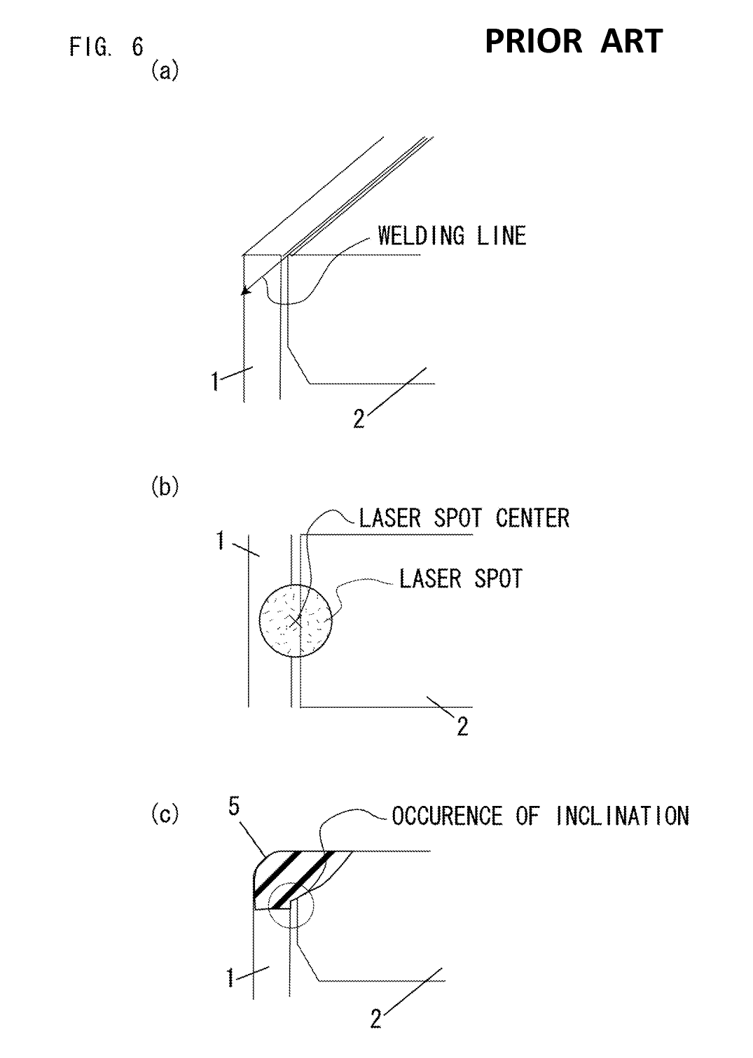

Also, as shown in FIGS. 6(a) and 6(b), it is found from FIG. 8 that when laser welding is performed with the spot center focusing on the middle of the gap between the outer casing 1 and the sealing plate 2 (Weld condition 2), the region in the outer casing 1 with a higher temperature than the melting point is deeper than the region in the sealing plate 2, and therefore an inclination occurs between the regions over the melting point. In contrast, it is found from FIG. 5 that when the spot center is shifted to the sealing plate side (Welding condition 4), the region over the melting point in the sealing plate 2 is slightly deeper, and is flatly formed at the boundary between the outer casing 1 and the sealing plate 2. In short, it is understood that when the temperature difference (the outer casing 1 minus the sealing plate 2) is less than 0, the deepest point of the melt-solidified portion is located in the sealing plate 2.

In view of the above simulation results, when welding of the sealing plate is performed without the offset, the following problems are considered to occur.
(1) As shown in FIG. 6(c), a melt-solidified portion 5 of the outer casing 1 is deeper than that of the sealing plate 2. This depth imbalance of the melt-solidified portion 5 prevents the weld portion from having sufficient strength.

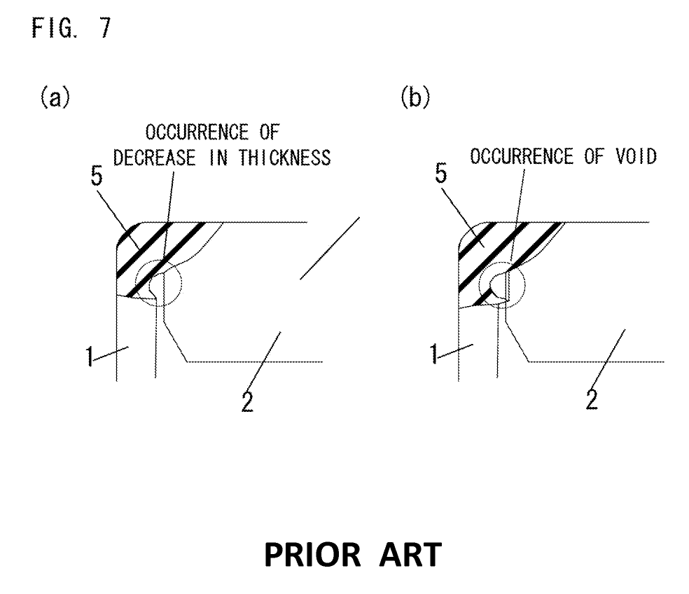

(2) Due to unevenness of the melting state, the material melt on the side of the outer casing mainly flows into the gap between the outer casing 1 and the sealing plate 2. This inflow of the material draws surrounding material of the outer casing 1 to the gap side, and thus a portion having a decreased thickness is generated in the outer casing 1 (FIG. 7(a) reference). This portion having a decreased thickness leads to a reduction in weld strength.
(3) When the melted outer casing 1 comes in contact with the melted sealing plate 2 at a deep position, the residual heat melts another part in the sealing plate 2, and thus the above-described portion having a decreased thickness is surrounded with the melted material to form a void. Although this void moves upward (the upper surface side) because of buoyancy, since the melted material is solidified to form a melt-solidified portion 5 before the void gets out, the void remains in the melt-solidified portion 5 (cf. FIG. 7(b)). This void may lead to a decrease in weld strength.

In contrast, when welding with the spot center shifting toward the sealing plate, it is believed that the problem described above is solved for the following reasons.

As shown in FIG. 2(c), the depths of the melt-solidified portions 5 in the outer casing 1 and the sealing plate 2 become almost the same as each other, and therefore the imbalance of the depths of the melt-solidified portions 5 is eliminated, thus sufficiently improving weld strength and suppressing occurrence of voids.

While the material melted by the laser heat flows in the gap between the outer casing 1 and the sealing plate 2, the offset of the laser spot center toward the sealing plate 2 allows the melted material to mainly flow from the sealing plate side having sufficient wall thickness compared to the outer casing 1. Thereby, an influence of the reduction in thickness of the material due to the inflow can be significantly decreased.

### Comparative Example 1

The cell according to Comparative Example 1 was fabricated in the manner similar to the above Embodiment except that laser welding was carried out with the offset as 30 μm.

### [Measurement of Welding Defects]

One thousand cells according to Comparative Example 1 were prepared to confirm the internal state of the melt-solidified portion using X ray. Then, when a void was found within 100 μm depth from the surface, the cell was judged as bad. Meanwhile, when a void was found at more than 100 μm depth from the surface, or when any void was not found, the cell was judged as good. As a result, the defect rate was 1.5%.

In addition, the defective weld in Comparative Example 1 was further investigated using X-rays, and thereby it was found that the welding defects (voids) were concentrated at the corners (cf. FIG. 3(a)).

This can be explained as follows. In Comparative Example 1, for the purpose of preventing an improper fitting of the sealing plate 2 at the corners, the gap clearance between the outer casing 1 and the sealing plate 2 at the corners is made greater than the gap clearance at the linear portion. However, the gap has low thermal conductivity, and therefore an imbalance of heat distribution between the outer casing 1 and the sealing plate 2 is apt to occur at the corners. When the imbalance of heat distribution occurs, as mentioned above, welding defects such as voids tend to be generated.

In view of the above, it is considered that when the offset at the corners is more than the offset at the linear portion, occurrence of the welding defects (voids) at the corners can be suppressed.

### Example 1

The cell according to Example 1 was fabricated in the manner similar to Comparative Example 1 except that the maximum offset at the corners is more than the offset at the linear portion. (the offset of the linear portion: 30 μm, the maximum offset at the corners: 100 μm).

One thousand cells according to Example 1 were prepared to confirm presence of the welding defects as described above. As a result, the defect rate was 0.8%.

Thus, it was confirmed that the maximum offset at the corners being more than the offset of the linear portion prevents the imbalance of heat distribution between the outer casing 1 and the sealing plate 2 at the corners, and therefore occurrence of the welding defects (voids) can be prevented.

In addition, the defective weld of Example 1 was further investigated using X-ray, and thereby it was confirmed that welding defects (voids) are concentrated at the corner to be welded first.

This can be explained as follows. Since the material of the sealing plate 2 expands due to the laser heat, dimensions of the outer casing 1 and the sealing plate 2 increase with time of the welding (heat accommodation). However, the effect of the heat at the corner to be welded first is small because the expansion has not yet progressed, while the effect of the heat at the other corners is large. Therefore, a substantial offset at the corner to be welded first is smaller than that at the other corners, and thus an imbalance of heat distribution between the outer casing 1 and the sealing plate 2 can easily occur at the corner to be welded first.

### Example 2

The cell according to Example 2 was fabricated in the manner similar to Example 1 except that the maximum offset at a corner to be welded first is more than the maximum offset at the other corners. (the offset of the linear portion: 30 μm, the maximum offset at the corner to be welded first: 130 μm, the maximum offset of the other corners: 100 μm).

One thousand cells according to Example 2 were prepared to confirm presence of the welding defects as described above. As a result, the defect rate was 0.3%.

From the above results, it is confirmed that when the maximum offset at the corner to be welded first is more than the maximum offset at the other corners, the imbalance of heat distribution between the outer casing 1 and the sealing plate 2 can be made extremely small at the corner to be welded first, and thereby occurrence of weld defects (voids) can be prevented at the corner to be welded first.

In view of the above, it is found that in order to suppress occurrence of welding defects, it is effective to increase the maximum offset in the corner to more than the offset in the linear portion. In addition, it is also found that occurrence of welding defects can be suppressed more effectively when the maximum offset at the corner to be welded first is more than the offset at the other corners.

### (Supplementary Remarks)

In the embodiment described above, a continuous wave type laser is used as a high energy beam, but a pulsed laser, an electron beam and the like may be also used.

It is more preferable to vary the offset depending on the following conditions: laser output conditions such as laser spot diameter, power density and scanning speed; the thicknesses of the outer casing and the sealing plate; the width of the gap between the outer casing and the sealing plate; the materials of the outer casing and the sealing plate. For example, it is desirable to decrease the offset if the laser spot diameter is small, and to increase the offset if the power density is large.

In addition, when the deepest part (the point having the greatest distance from the upper surface of the sealing plate) of the melt-solidified portion, which is formed by melt of each corner with laser heat and subsequent solidification, is positioned in the sealing plate, it is possible to perform welding in good heat balance on both sides of the outer casing and the sealing plate.

The above Embodiment has been described using an example applying the present invention to a non-aqueous electrolyte secondary cell. However, the present invention can be applied to all cells using laser welding between a prismatic outer casing and a substantially planar rectangular sealing plate, and therefore can be applied to other cells such as nickel-cadmium and nickel-hydrogen cells.

As described above, the present invention can provide a prismatic sealed cell having an excellent reliability in sealing, which can suppress an occurrence of welding defects. Thus, the industrial applicability is significant.

### DESCRIPTION OF NUMERAL REFERENCES

1 Outer casing
2 Sealing plate
3 External terminal
4 External terminal
5 Melt-solidified portion

What is claimed is:

1. A method of manufacturing a sealed cell comprising:
fitting a substantially planar rectangular sealing plate to the opening of a prismatic outer casing; and
irradiating a high energy beam so that the spot center of the beam is shifted from the fitted portion to the sealing plate side in order to seal the sealing plate and the outer casing,
wherein the following formulas are satisfied: L3<L2 and L3<L1,
wherein L1 is the maximum distance from the outer periphery of the sealing plate to the spot center at a corner to be welded first among the four corners of the sealing plate, L2 is the maximum distance from the outer periphery of the sealing plate to the spot center at the other corners than the corner to be welded first, and L3 is the distance from the outer periphery of the sealing plate to the spot center at a linear portion of the sealing plate.

2. The method for manufacturing a prismatic sealed cell according to claim 1, wherein the following formula is satisfied: L2<L1.

3. The method for manufacturing a prismatic sealed cell according to claim 1, wherein L1 is 50 to 380 μm, L2 is 20 to 350 μm, and L3 is 0 to 250 μm.

4. The method for manufacturing a prismatic sealed cell according to claim 1, wherein the sealing plate is made of pure aluminum or aluminum alloy, and the prismatic outer casing is made of pure aluminum or aluminum alloy.

5. The method for manufacturing a prismatic sealed cell according to claim 1, wherein the high energy beam is a laser.

6. The method for manufacturing a prismatic sealed cell according to claim 5, wherein the laser is a continuous wave type laser.
